(19) United States
(12) Patent Application Publication
(10) Pub. No.: US 2017/0113827 A1
(43) Pub. Date: Apr. 27, 2017

(54) LABEL ALIGNMENT METHOD, SYSTEM, AND APPARATUS

(71) Applicant: Honda Motor Co., Ltd., Tokyo (JP)

(72) Inventors: BENJAMIN MACARTHUR, Barrie (CA); ROBERT J. CHAMBERS, Keswick (CA); ROBERT P. EAGAN, Tottenham (CA)

(21) Appl. No.: 14/919,277

(22) Filed: Oct. 21, 2015

(51) Int. Cl. B65C 9/26

(52) U.S. Cl. CPC B65C 9/26

(57) ABSTRACT

A method, system, and apparatus for transferring a label from a strip of labels to an attachment location includes a presenter jig that includes a label flow path between first and second guides for guiding the strip of labels, a cylinder for advancing the strip of labels, a label alignment lock that centers and locks into place one label from the strip of labels, and an installation jig. The installation jig includes a pickup tool having at least one suction cup for lifting the label from the strip of labels. The pickup tool is rotatable to align the pickup tool with a receiving location. The pickup tool releases the at least one suction cup to drop the label onto the receiving location.

### BACKGROUND

Industrial labels are often difficult to peel and apply. A label dispenser can speed up this task. A label alignment system and method is presented for removing labels, particularly Vehicle Identification Numbers (VIN) labels on motor vehicles.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a system for transferring a label from a strip of labels to an attachment location includes a presenter jig includes a label flow path between first and second guides for guiding the strip of labels, a cylinder for advancing the strip of labels, a label alignment lock that centers and locks into place one label from the strip of labels, and an installation jig. The installation jig includes a pickup tool having at least one suction cup for lifting the label from the strip of labels. The pickup tool is rotatable to align the pickup tool with a receiving location. The pickup tool releases the at least one suction cup to drop the label onto the receiving location.

According to another aspect, an apparatus for transferring a label from a strip of labels to an attachment location includes a presenter jig that includes a label flow path between first and second guides for guiding the strip of labels, a cylinder for advancing the strip of labels, a switch that controls movement of the cylinder, a label alignment lock that centers and locks into place one label from the strip of labels, and a separator, the separator lifting the label from the sheet of labels. The apparatus also includes an installation jig that includes a pickup tool having at least one suction cup for lifting the label from the strip of labels, a vacuum source for removing air from the at least one suction cup when in contact with the label to create a vacuum, and a switch for releasing air into the vacuum, thereby releasing the at least one suction cup from the label. The pickup tool is rotatable to align the pickup tool with a receiving location. The pickup tool releases the at least one suction cup to drop the label onto the receiving location.

According to yet another aspect, a method of moving a label from a strip of labels on a presenter jig to an article of manufacture using an installation jig including the steps of feeding the strip of labels between a pair of guides using a cylinder, locking a cylinder in place when the label on the strip of labels is centered in an aperture on the presenter jig, removing the label with the installation jig, and placing the label on the article of manufacture.

### BRIEF DESCRIPTION OF THE DRAWINGS

FIG. 1 is a top view of a presenter jig of a label alignment system.

FIG. 2 is a close up view of a portion of presenter jig of the label alignment system of FIG. 1.

FIG. 3 is a top view of the label alignment system.

FIG. 4 is a top view of an installation jig of the label alignment system.

FIG. 5 is a front view of the installation jig of the label alignment system.

FIG. 6 is a rear view of the installation jig of the label alignment system.

The figures depict various embodiments of the embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

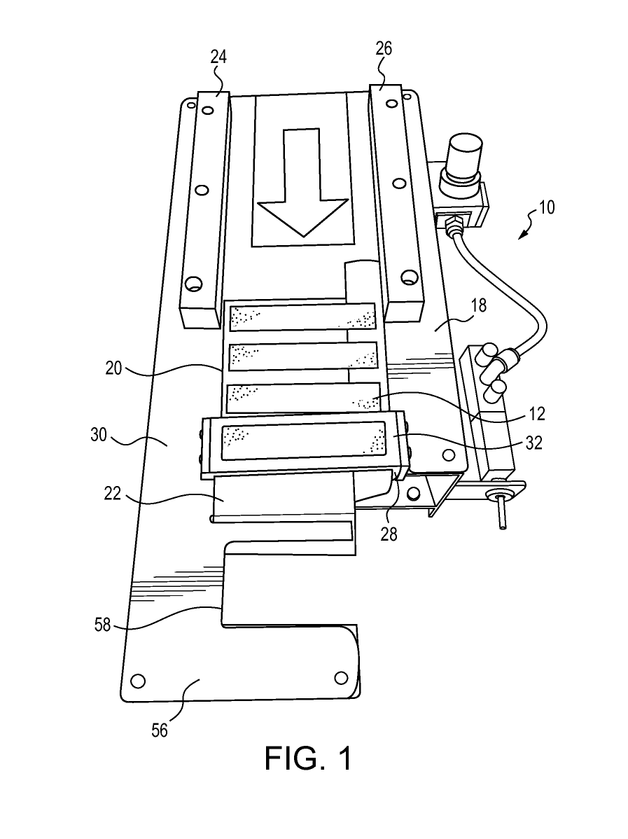

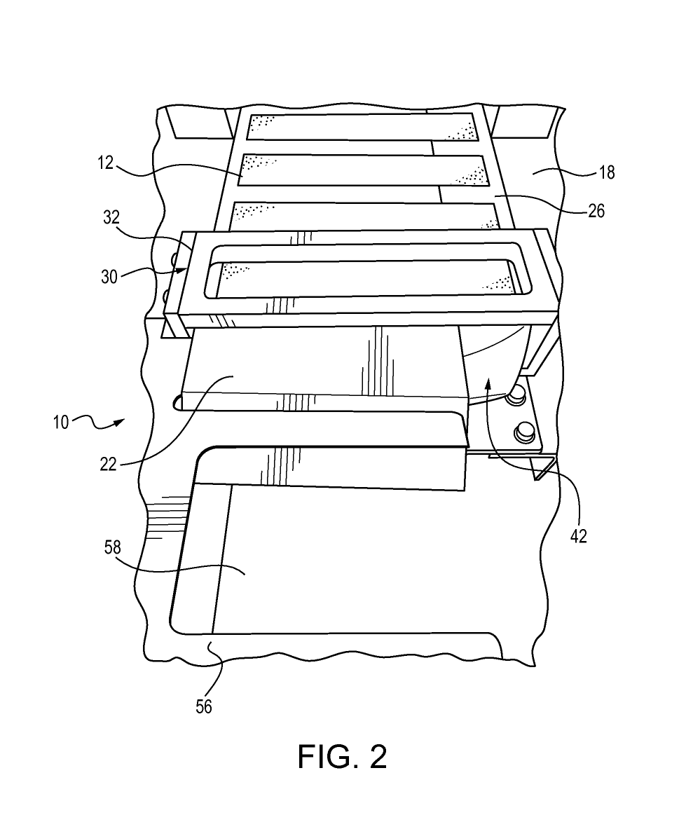

The embodiment shown in FIGS. 1-6 illustrates a label alignment system 10 for attaching labels 12 to a part 14 of a motor vehicle 16. In the embodiment, the label 12 is a vehicle identification number (VIN) label, but the label alignment system 10 may be applicable with other types of labels. Also, in the illustrated embodiment, the label 12 is attached to a part 14 of a motor vehicle 16, but the label alignment system 10 may be used with other articles of manufacture.

A presenter jig 18 is provided to feed labels 12 located on a roll 20. Although the embodiment illustrated in FIGS. 1-6 shows application labels 12 from a roll 20, the labels 12 may also be presented on a sheet or any other suitable delivery system known to those skilled in the art. Labels 12 may be supplied separately or on a roll or sheet. Many labels 12 are pre-printed by the manufacturer. Other labels 12 have printing applied manually or automatically at the time of application. Labels 12 may also have protective overcoats, laminates, or tape to cover them after the final print is applied. Protective overcoats may be applied before or after application.

Pressure-sensitive adhesives (also called PSA or self-stick) are applied with light pressure without activation or heat. Rolls 20 of labels 12 often have release liners 22 which protect the adhesive and assist label 12 handling. A release liner 22 is a paper or plastic-based film sheet (usually applied during the manufacturing process) used to prevent a sticky surface from prematurely adhering. The release liner 22 may be coated on one or both sides with a release agent, which provides a release effect against any type of a sticky material such as an adhesive or mastic.

Completed rolls 20 of labels 12 are fed into a presenter jig 18 between guides 24,26, as shown in FIGS. 1, 3, and 4. The guides 24,26 may be laterally adjusted to accommodate labels 12 and rolls 20 of variable widths. The presenter jig 18 further includes a cylinder 28 coated with a high-friction surface, such as rubber or any other material known to one skilled in the art, that feeds the label 12 roll 20 into a label alignment lock down point 30. When the cylinder 28 has fed the label 12 into a centered position at the label alignment lock down point 30, the cylinder 28 is locked in a manner known to those skilled in the art.

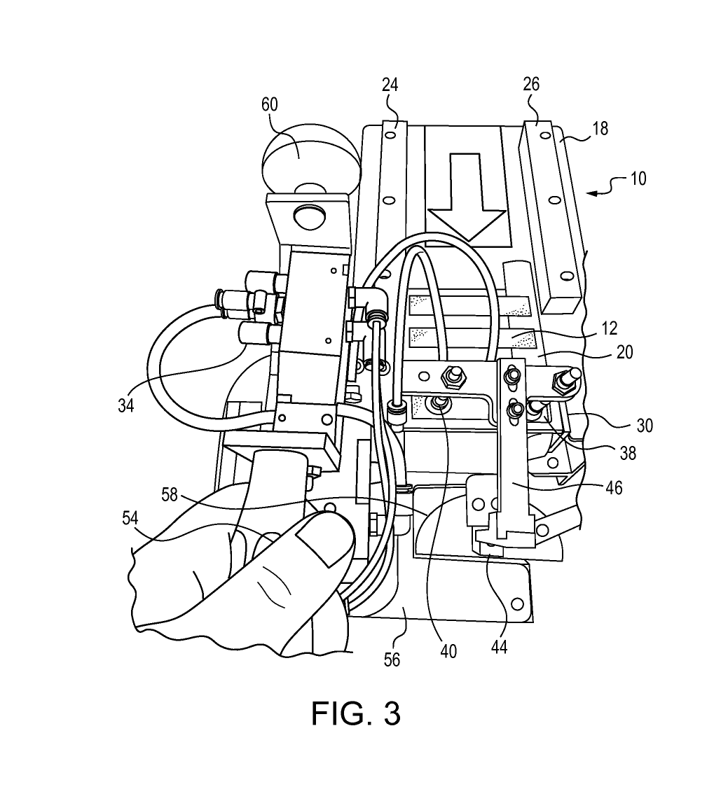

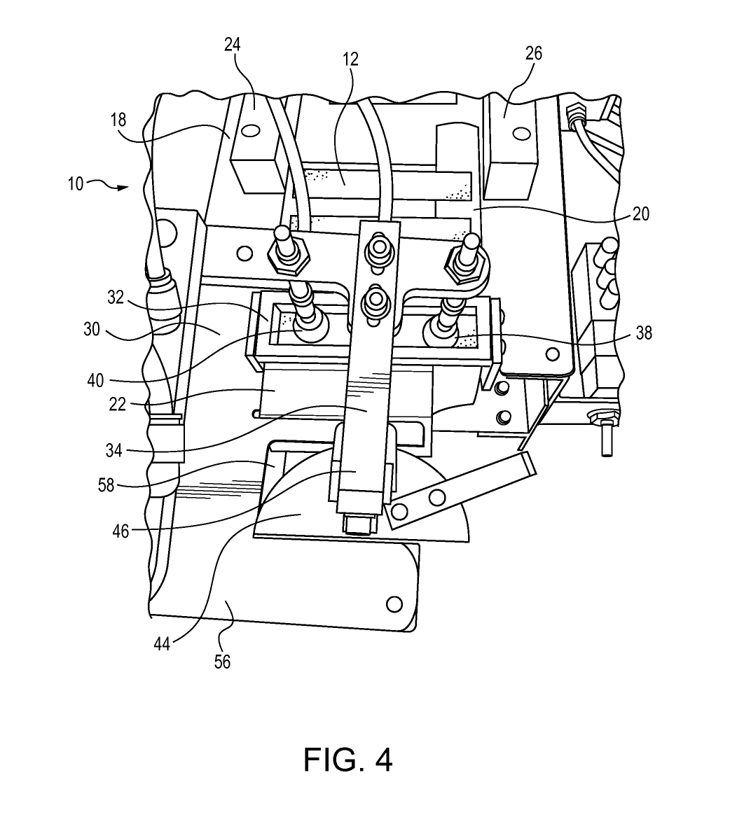

Also located at the label alignment lock down point 30 is an aperture 32 located above the cylinder 28. As shown in FIGS. 3-4, once the label 12 is centered and the cylinder 28 locked, an installation jig 34 is aligned with the aperture 32 on the presenter jig 18, through which the installation jig 34 picks up the label 12.

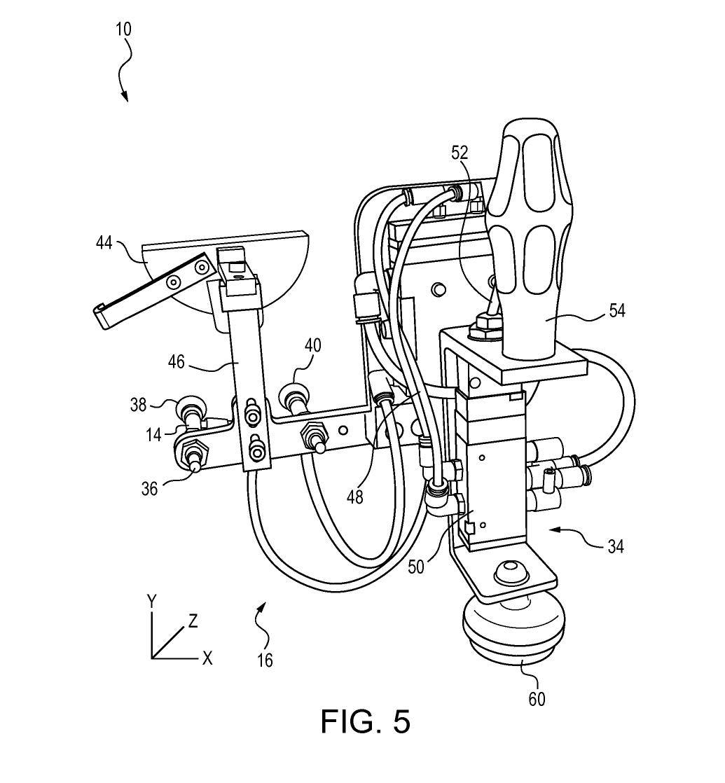

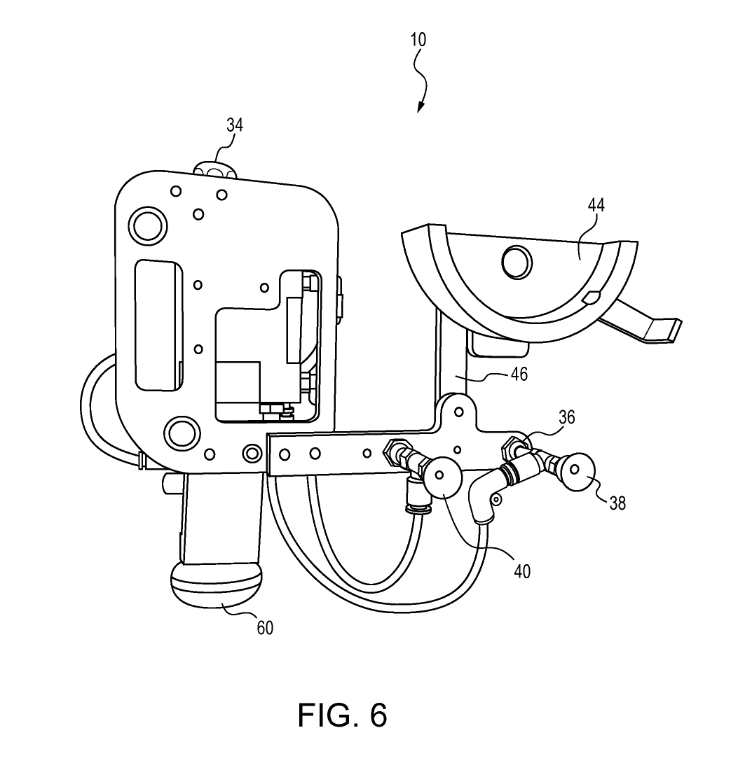

The installation jig 34 includes a pickup tool 36 equipped with at least one suction cup 38 to remove the label 12 from the roll 20 of labels 12. The pickup tool 36 in the embodiment illustrated in FIGS. 5-6 includes two (2) suction cups 38,40. The suction cups 38,40 are placed against the label 12, and a switch 42 is actuated to engage a vacuum that removes air from the space between the suction cups 38,40 and label 12, creating a vacuum connection between the suction cups 38,40 and the label 12.

In order to make removal of the label 12 from the roll 20 easier, the presenter jig 18 may include a separator 42 to lift a portion or the entire label 12 from the roll 20 in order to facilitate removal of the label 12.

In the embodiment illustrated in the FIGS. 1-6, the installation jig 34 is used to transfer a label 12 from the presenter jig 18 to a motor vehicle part 14. The installation jig 34 includes a datum 44 that aligns with the motor vehicle part 14 to ensure proper placement of the label 12 when the pickup tool 36 is moved to the motor vehicle part 14 from the presenter jig 18. The datum 44 sits at the end of an arm 46 that is adjustable in each of the x, y, and z planes. The allows the installation jig 34 to be used with different motor vehicles 16 and motor vehicle parts 14 that have different shapes, sizes, and locations for labels 12.

The suction cups 38,40 are connected to a small vacuum system 48 controlled by a solenoid 50 known to those skilled in the art. The vacuum created by the suction cups 38,40 when set against the label 12 may be actuated by a typical on/off switch 52, which operates the solenoid 50 to create the vacuum in the suction cups 38,40 when turned on, and releases the vacuum when turned off. Once the label 12 is in position, a switch 52 shuts off the vacuum and the label 12 falls from the pickup tool 36 onto the motor vehicle part 14.

The installation jig 34 may contain a rear handle 54 to lift the installation jig 34 from a resting location 56 on the presenter jig 18. The resting location 56 includes a slot 58 for receiving the datum 44 of the installation jig 34 to ensure that the suction cups 38,40 of the pickup tool 36 will be aligned with the aperture 32 of the presenter jig 18. The installation jig 34 may also include a front support handle 60 for enabling a user to move the installation jig 34 into position on the motor vehicle part 14.

The installation jig 34 may be operated by a human operator, or the installation jig 34 may be positioned on a robot (not shown) in a manufacturing environment in a method known to those skilled in the art.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A system for transferring a label from a strip of labels to an attachment location, comprising:
a presenter jig, comprising
a label flow path between first and second guides for guiding the strip of labels;
a cylinder for advancing the strip of labels;
a label alignment lock that centers and locks into place one label from the strip of labels; and
an installation jig, comprising
a pickup tool having at least one suction cup for lifting the label from the strip of labels;
wherein the pickup tool is rotatable to align the pickup tool with a receiving location; and
wherein the pickup tool releases the at least one suction cup to drop the label onto the receiving location.

2. The system of claim 1 wherein the label alignment lock further comprises
a switch that controls movement of the cylinder.

3. The system of claim 1 further comprising:
a separator, the separator lifting the label from the sheet of labels.

4. The system of claim 1 wherein the at least one suction cup further comprises:
a vacuum source for removing air from the at least one suction cup when in contact with the label to create a vacuum; and
a switch for releasing air into the vacuum, thereby releasing the at least one suction cup from the label.

5. An apparatus for transferring a label from a strip of labels to an attachment location, comprising:
a presenter jig, comprising:
a label flow path between first and second guides for guiding the strip of labels;
a cylinder for advancing the strip of labels;
a switch that controls movement of the cylinder;
a label alignment lock that centers and locks into place one label from the strip of labels; and
a separator, the separator lifting the label from the sheet of labels; and
an installation jig, comprising:
a pickup tool having at least one suction cup for lifting the label from the strip of labels;
a vacuum source for removing air from the at least one suction cup when in contact with the label to create a vacuum;
a switch for releasing air into the vacuum, thereby releasing the at least one suction cup from the label;
wherein the pickup tool is rotatable to align the pickup tool with a receiving location; and
wherein the pickup tool releases the at least one suction cup to drop the label onto the receiving location.

6. A method of moving a label from a strip of labels on a presenter jig to an article of manufacture using an installation jig, comprising the steps of:
feeding the strip of labels between a pair of guides using a cylinder;
locking a cylinder in place when the label on the strip of labels is centered in an aperture on the presenter jig;
removing the label with the installation jig; and
placing the label on the article of manufacture.

7. The method of claim 6, further comprising the step of:
separating the label from the strip of labels prior to the step of removing the label to ease removing the label.

8. The method of claim 7, wherein the steps of removing the label and placing the label further comprises the steps of:
contacting at least one suction cup located on the installation jig with the label;
turning on a vacuum switch to create a vacuum between the at least one suction cup and the label, thereby temporarily creating a connection between the at least one suction cup and the label;
removing the label from the strip of labels;
placing the label on the article of manufacture; and
turning off the vacuum switch to release the label from the at least one suction cup.
